(19) United States
(12) Patent Application Publication
(10) Pub. No.: US 2008/0247346 A1
(43) Pub. Date: Oct. 9, 2008

(54) COMMUNICATION NODE WITH MULTIPLE ACCESS SUPPORT

(75) Inventors: Giorgi Gulbani, Espoo (FI); Paul K. Sitch, Palo Alto, CA (US); Vesa Hellgren, Helsinki (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/964,654

(22) Filed: Dec. 26, 2007

Related U.S. Application Data
(60) Provisional application No. 60/882,857, filed on Dec. 29, 2006.

(51) Int. Cl. H04B 7/00

(52) U.S. Cl. 370/310

(57) ABSTRACT

A node configured to communicate with a user equipment via at least two access network domains. The node is configured to generate access network domain selection information, and further configured to route data packets dependent on the network domain selection information

### BACKGROUND OF THE INVENTION

1. Field of the Invention

The present invention relates to a node in a communication system, and in particular, but not exclusively, to a node in a communication system communicating over at least one domain network.

2. Description of the Related Art

A communication system can be seen as a facility that enables communication sessions between two or more entities such as user equipment, controllers and/or other nodes associated with the system. The communication may comprise, for example, communication of voice, video, data, multimedia and so on. An application session may, for example, comprise a two-way telephone call or multi-way conference session or connection between a user equipment and an application server (AS), such as a service provider server or proxy. The establishment of communication sessions generally enables a user to be provided with various services.

Signalling between various entities associated with a communication session is typically required in order to control the communication session. Control is typically required for the set-up of the communication session and also later on during communication on the established communication session. The signalling can be based on an appropriate communication protocol or protocols.

The communication may be provided by fixed line and/or wireless communication interfaces. An example of the fixed line system is a public switched telephone network (PSTN). The wireless communication may be provided by means of a mobile communication system. Mobile communication systems refers generally to any telecommunications systems which enable a wireless communication when users are moving within the service area of the system. An example of a typical mobile communication system is a Public Land Mobile Network (PLMN).

The mobile communications network can provide an access network providing a user with a wireless access to external networks, hosts, or services offered by specific service providers.

An access point or gateway node of the mobile communication network provides further access to an external network or an external host. For example, if the requested service is provided by a service provider located in another network, the service request is routed via a gateway to the other network and the service provider. The routing may be based on definitions in the mobile subscription information stored in the mobile network.

A more detailed example will now be described with reference to general packet radio service (GPRS). The GPRS operational environment comprises one or more subnetwork service areas, which are interconnected by a GPRS backbone network. A subnetwork may comprise a number of packet data service nodes (SN). In this specification the service nodes will be referred to as serving GPRS support nodes (SGSN). Each of the SGSNs is connected to radio networks, typically to base station systems and/or radio access networks by way of base station controllers (BSC) and/or radio network controllers (RNC) in such a way that they can provide a packet service for mobile user equipment via several base stations, i.e. cells. The intermediate mobile communication network provides packet-switched data transmission between a support node and mobile user equipment. The subnetworks are in turn connected to an external data network, e.g. to a packet data network (PDN), via GPRS gateway support nodes (GGSN). The GPRS thus allow transmission of packet data between mobile user equipment and external data networks.

Other radio access networks are also available. There is interest in being able to switch between or use overlapping networks concurrently. For example to be able to carry out a voice call over a conventional 3G or GPRS network while connecting to a interworking wireless local area network (I-WLAN) connection so to access images or video at the same time. Some wireless local area network domains use a process known as tunnel termination gateway (TTG) to simulate both control plane (GTP-C) and user plane (GTP-U) GPRS tunnelling protocol (GTP) tunnelling in non GPRS network domains.

A packet data protocol (PDP) context may be established to carry traffic flows over the communication system. A PDP context typically includes a radio access bearer provided between the user equipment, the radio network controller and the SGSN, and switched packet data channels provided between the serving GPRS service node and the gateway GPRS service node. A session between the user equipment and other party would then be carried on the established PDP context. A PDP context can carry more than one traffic flow, but all traffic flows within one particular PDP context are treated the same way as regards their transmission across the network. This requirement regarding the similar treatment is based on PDP context treatment attributes associated with the traffic flows. These attributes may comprise, for example, quality of service and/or charging attributes.

In both the GPRS and the I-WLAN networks, the mobile user equipment may optionally indicate, in a message requesting to activate a packet data protocol (PDP) context in the network, an access point name (APN) for selection of a reference point to a certain external network. A Serving GPRS support node (SGSN) may authenticate the mobile user and send a PDP context creation request to a gateway node (GGSN) selected e.g. according to the access point name given by the user equipment, or to a default GGSN known by the SGSN/TTG.

Various user equipment (UE) such as computers (fixed or portable), mobile telephones and other mobile stations, personal data assistants or organizers, and so on are known to the skilled person. These all can be used to access the packet data networks, e.g. corporate intranets or the Internet, to obtain services. Mobile user equipment, typically referred to as a mobile station (MS), can be defined as a means that is capable of communication via a wireless interface with another device such as a base station of a mobile telecommunication network or any other station. The increasing popularity of Third Generation (3G) communication systems will, in all likelihood, significantly increase the possibilities for accessing services on the packet data networks via mobile user equipment (UE) as well as other types of UE.

The term “service” used above and hereinafter will generally be understood to broadly cover any service or goods which a user may desire, require or be provided with. The term also will generally be understood to cover the provision of complementary services. In particular, but not exclusively, the term “service” will be understood to include browsing, downloading, email, streaming services, Internet Protocol multimedia (IM) services, conferencing, telephony, gaming, rich call, presence, e-commerce and messaging, for example, instant messaging.

In a communications system where the user equipment is attached to both the SGSN and the interworking wireless local area network domains, and where furthermore the user equipment accesses the same access point name (APN) access point (in other words the same GGSN for both network domains) and uses the same internet protocol address in both PDP contacts there can be problems.

The user equipment with a first PDP context at the SGSN and with the GGSN with a given APN and IP address may not have a traffic flow template (TFT) associated with the first PDP context. In which case, the SGSN and GGSN establish a GPRS tunnelling protocol-control (GTP-C) plane for control signals passing from the GGSN and the user equipment via the SGSN, and a GPRS tunnelling protocol—user (GTP-U) plane transferring user data between the user equipment and GGSN via the SGSN.

At the same time, any user equipment establishing a GTP tunnel to the tunnel termination gateway (TTG) in the Interworking Wireless Local Area Network (I-WLAN) domain sets up a second PDP context with the GGSN. The TTG receives the request and attempts to establish a corresponding PDP context at the GGSN. However, as the user equipment cannot exchange a traffic flow template with the tunnel termination gateway (TTG) and the GGSN already has a PDP context for this user with the same IP address which does not have a traffic flow template the GGSN is forced to reject the second PDP context activation request.

This is specified in the Third Generation Partnership Project document 3GPP TS 23.060 section 15.3. which specifies that PDP contexts that share the same PDP address and APN pair shall without an associated TFT only have a maximum of one PDP context. For every established PDP context of a PDP address and APN pair associated with a TFT this allows a new PDP context however this granting of further PDP contexts is carried out by means of a secondary PDP context activation procedure.

This restriction is in place as if more than one PDP context was allowed so that one context ran via the TTG in the I-WLAN and a second context ran via the SGSN in the GRPS/3G network then the GGSN can not determine how to route the downlink packets—in terms of which access point to use.

There is therefore no currently known means which permit concurrent PDP contexts from separate network domains without the setting up of an initial traffic flow template (TFT) from the user equipment. In multiple access domains where TTGs are used this presents a significant problem since there is no standardised Third Generation Partnership Project (3GPP) mechanism by which the user equipment can exchange a TFT with the tunnel termination gateway.

### SUMMARY OF THE INVENTION

Embodiments of the present invention aim to address one or several of the above problems.

There is provided according to a first aspect of the present invention a node configured to communicate with a user equipment via at least two access network domains, wherein the node is configured to generate access network domain selection information, and wherein the node is further configured to route data packets dependent on the network domain selection information.

The node is preferably further configured to generate the access network domain selection information dependent on receiving a first data packet from the user equipment via at least one of the access network domains.

The node is preferably further arranged to edit the access network domain selection information dependent on receiving a further data packet from the user equipment via a further access network domain.

The access network domain selection information is preferably a traffic flow template filter.

The traffic flow template filter may comprise a context filter which identifies each context with an access network domain.

Each context may comprise a Packet Data Protocol Context.

The first data packet from the user equipment via at least one of the access network domains may comprise a tunnelled packet.

The tunnelled packet is preferably a GPRS Tunnelling Protocol (GTP) packet. The tunnelled packet may comprise a first packet transmitted via a first context. The node is preferably a Gateway GPRS support node (GGSN).

The node is preferably configured to generate access network domain selection information dependent on at least one characteristic of the at least two access network domains.

The characteristic of the at least two access network domains may comprise at least one of: transmission delay; error rate; and bandwidth.

The at least one access network domain may comprise at least one of: 3G radio access network; GRPS radio access network; I-WLAN radio access network; Universal Mobile Telecommunication System (UMTS) radio access network; i-phone radio access network; CDMA2000 radio access network; Terrestrial Trunked Radio (TETRA) system radio access network; Enhanced Data rate for GSM Evolution (EDGE) radio access network; Worldwide Interoperability for Microwave Access (WiMax) radio access networks; A IEEE 802.16 compliant radio access network; High Performance Metropolitan Access Network (HiPerman); and Wireless Broadband (WiBro) access network.

The node is preferably configured to generate access network domain selection information further dependent on determining the absence of current access network domain selection information in the node.

According to a second aspect of the present invention there is provided a node configured to communicate with a user equipment via at least one radio access network domain, wherein the node is configured to generate radio access network domain selection information on receiving a first packet from the user equipment via the first radio access network domain, and wherein the node is further configured to select at least one radio access network domain to transmit packets to the user equipment dependent on the radio access network domain selection information.

According to a third aspect of the present invention there is provided a node configured to communicate with a user equipment via at least two access network domains, wherein the node comprises: means for generating access network domain selection information; and means for routing data packets dependent on the network domain selection information.

According to a fourth aspect of the present invention there is provided a method for communicating with a user equipment via at least two access network domains, comprising: generating access network domain selection information, and routing data packets dependent on the network domain selection information.

The method may comprise: receiving a first data packet from the user equipment via at least one of the access network domains; and generating the access network domain selection information dependent on receiving the first data packet from the user equipment via at least one of the access network domains.

The method may further comprise: receiving a further data packet from the user equipment via a further access domain; editing the access network domain selection information dependent on receiving a further data packet from the user equipment via a further access network domain.

The access network domain selection information is preferably a traffic flow template filter.

The traffic flow template filter may comprise a context filter which identifies each context with an access network domain.

Each context may comprise a Packet Data Protocol Context.

The first data packet from the user equipment via at least one of the access network domains may comprise a tunnelled packet.

The tunnelled packet is preferably a GPRS Tunnelling Protocol (GTP) packet. The tunnelled packet may comprise a packet transmitted via a first context.

The method may comprise generating access network domain selection information dependent on at least one characteristic of the at least two access network domains.

The characteristic of the at least two access network domains may comprise at least one of: transmission delay; error rate; and bandwidth.

The at least one access network domain may comprise at least one of: 3G radio access network; GRPS radio access network; I-WLAN radio access network; Universal Mobile Telecommunication System (UMTS) radio access network; i-phone radio access network; CDMA2000 radio access network; Terrestrial Trunked Radio (TETRA) system radio access network; Enhanced Data rate for GSM Evolution (EDGE) radio access network; Worldwide Interoperability for Microwave Access (WiMax) radio access networks; A IEEE 802.16 compliant radio access network; High Performance Metropolitan Access Network (HiPerman); and Wireless Broadband (WiBro) access network.

Generating the access network domain selection information is preferably further dependent on determining the absence of current access network domain selection information in the node.

According to a fifth aspect of the present invention there is provided a computer program product configured to perform a method for communicating with a user equipment via at least two access network domains, comprising: generating access network domain selection information, and routing data packets dependent on the network domain selection information.

According to a sixth aspect of the present invention there is provided a communications system comprising: a user equipment and a node, wherein the user equipment and node are configured to communicate via at least a first network domain and at least a second network domain, wherein the node is arranged to generate access network domain selection information, and wherein the node is further configured to route data packets dependent on the network domain selection information.

According to a seventh aspect of the present invention there is provided a communications system comprising: a user equipment and a node, the node configured to communicate with a user equipment via a first access network domain and a second access network domain, wherein the user equipment communicates to the node via the first and second access networks concurrently. The user equipment is preferably configured to identify the node by a single internet protocol address, and access point name independent of the access network domain communication path.

### BRIEF DESCRIPTION OF DRAWINGS

For better understanding of the present invention, reference will now be made by way of example to the accompanying drawings in which:

FIG. 1 shows schematically a communication system wherein the present invention may be embodied; and

FIG. 2 show a signalling flowchart for exemplifying embodiments of the present invention.

### DETAILED DESCRIPTION OF THE PREFERRED EMBODIMENTS

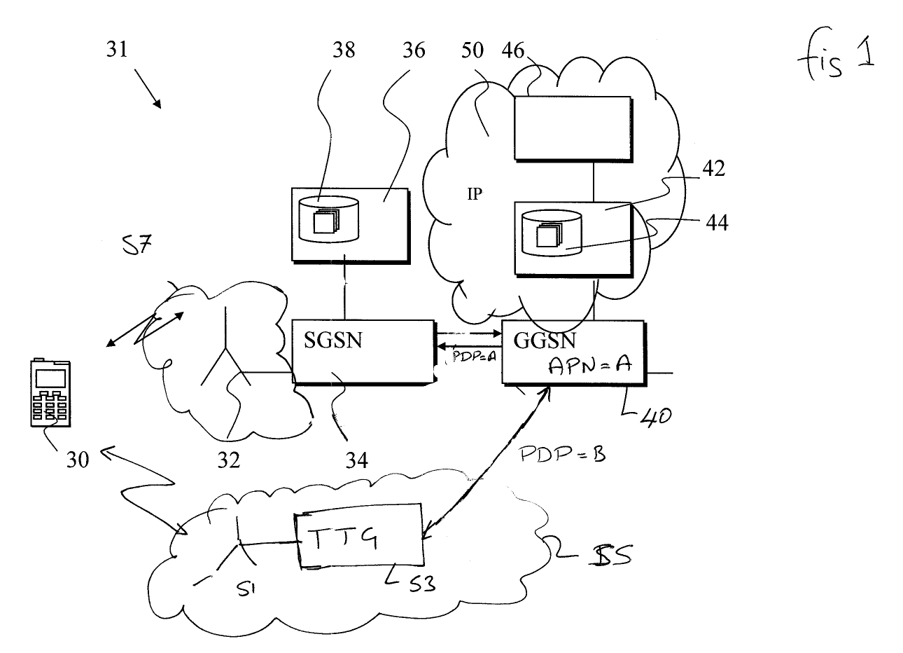

FIG. 1 shows a communication system according to certain embodiments of the present invention. More particularly, certain embodiments of the present invention will be described by way of example, with reference to the architecture of a third generation (3G) mobile communications system. However, it will be understood that certain embodiments may be applied to any other suitable form of network. The mobile communication system 31 is typically arranged to serve a plurality of mobile user equipment 30. Each user equipment is typically provided with a wireless interface between the user equipment and base station 32 of the communication system 31.

The basic operational principles of a mobile user equipment, that may also be referenced to as a mobile station, are generally known by those skilled person. A mobile user equipment is normally configured for wireless communication with other stations, typically with the base stations of a mobile communication system for enabling mobility thereof. A mobile user equipment may include an antenna element for wirelessly receiving and/or transmitting signals from and/or to the base stations of the mobile communication system. A mobile user equipment may also be provided with a display for displaying images and/or other graphical information for the user of the mobile user equipment. Speaker means are also typically provided. The operation of the mobile user equipment may be controlled by means of an appropriate user interface, such as control buttons, voice commands and so on. Furthermore, a mobile user equipment is typically provided with a processor entity and/or a memory means. Communication between the user equipment and the entities of the communication network may be based on any appropriate communication protocol. A user may use the mobile user equipment for tasks such as, but not limited to, for making and receiving phone calls, for receiving and sending data from and to the network and for experiencing, for example, multimedia content by means of PDP contexts. For example, a user may access the network by means of a Personal Computer (PC), Personal Data Assistant (PDA), mobile station (MS) and so on.

It shall be appreciated that, although for clarity, only one equipment is shown in FIG. 1, a number of user equipment may be in simultaneous communication with a base station.

A mobile communication system, in turn, may logically be divided between a radio access network (RAN) 57 and a core network (CN). In the simplified presentation of FIG. 1, the base station 32 belongs to the radio access network. It shall be appreciated that, although, for clarity, FIG. 1 shows the base station of only one 3G radio access network, a typical 3G/GPRS/GSM communication network system usually includes a number of 3G/GPRS/GSM radio access networks.

The 3G radio access network (RAN) 57 is typically controlled by appropriate radio network controller (RNC). This is not shown in order to enhance clarity. The radio access network controller is typically connected to an appropriate core network entity or entities such as, but not limited to, a serving general packet radio service support node (SGSN) 34. A subscriber information database entity 36 for storing information associated with the subscriber of the user equipment 30 is also shown. The HLR may contain various records 38 associated with the subscriber, such as details of PDP context subscriptions of the subscriber.

FIG. 1 also shows a second wireless communication radio access network domain 55. The I-WLAN access point comprises a base station 51. The I-WLAN base station 55 communicates to and from the user equipment 30 using methods as described in the 3rd generation partnership project (3GPP) technical specification document 3GPP TS 22.234.

In the I-WLAN domain control and user data is transmitted using GPRS Tunnelling

Protocols (GTP-C for control data, GTP-U for user data) between the GGSN of the core network and the Tunnel Termination Gateway (TTG) 53 of the I-WLAN domain 55. The Tunnel Termination Gateway is also linked to the I-WLAN base station 51 so that the control data and user data can pass between the I-WLAN base station 51 and the TTG 53.

A user equipment within the radio access network may communicate with a radio network controller via radio network channels which are typically referred to as radio bearers (RB). These radio network channels may be set up in a mobile communication system in a known manner. Each user equipment 30 may have one or more radio network channels open at any one time with the radio network controller. The 3G/GPRS radio access network controller is in communication with the serving GPRS support node (SGSN) 34 via an appropriate interface, for example on an lu interface.

The serving GPRS support node 34, in turn, typically communicates with a gateway GPRS support node (GGSN) 40 via the GPRS backbone network on interface 39. This interface is commonly a switched packet data interface. The serving GPRS support node 34 and/or the gateway GPRS support node 40 are for provision of support for GPRS services in the network.

Overall communication between user equipment 30 in the access entity and the gateway GPRS support node 40 is generally provided by a packet data protocol (PDP) context. Each PDP context usually provides a communication pathway between a particular user equipment 30 and the gateway GPRS support node 40. Once established, a PDP context can typically carry multiple flows. Each flow normally represents, for example, a particular service and/or a component of a particular service. The PDP context therefore often represents a logical communication pathway for one or more flows across the network. To implement the PDP context between user equipment 30 and the serving GPRS support node 40, radio access bearers (RAB) are usually established which commonly allow for data transfer for the user equipment. The implementation of these logical and physical channels is known to those skilled in the art and is therefore not discussed further herein.

The user equipment may connect, via the GPRS network, to servers that are generally connected to an external packet data network such as, but not limited to, the exemplifying Internet Protocol (IP) network 50.

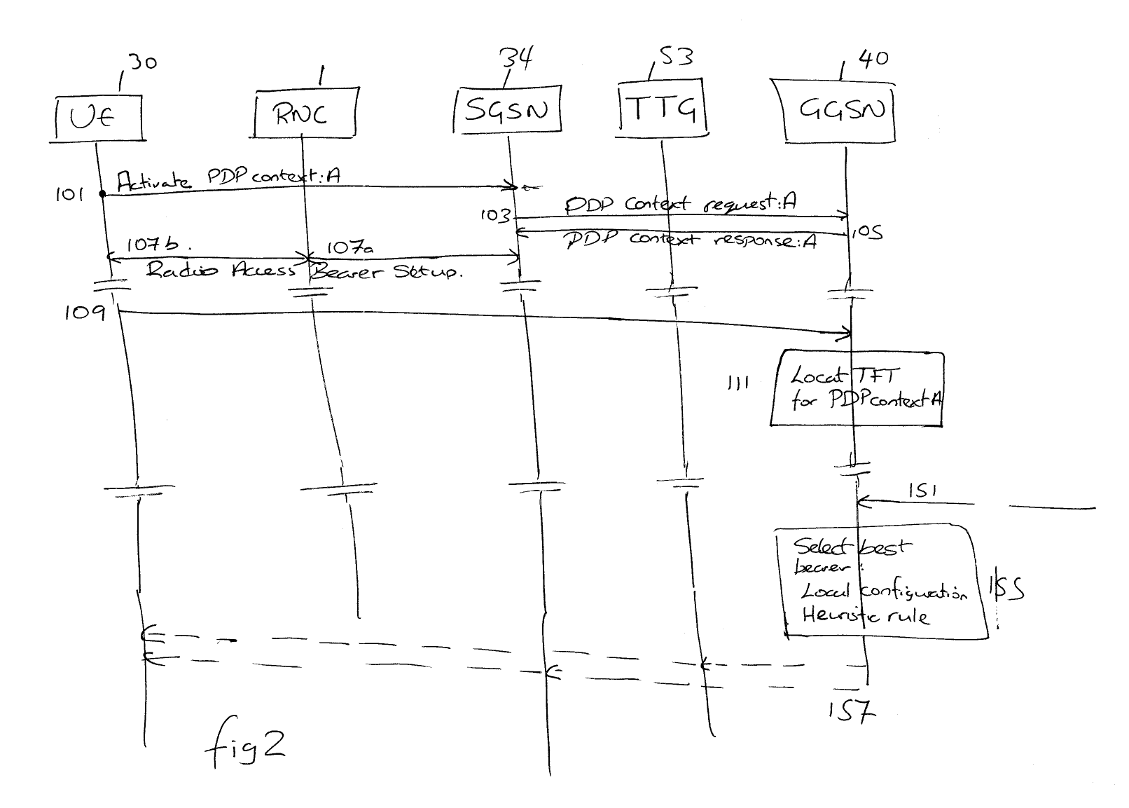

FIG. 2 shows an example the operation of embodiments of the present invention. Steps 101 to 107 show the process of activation of a PDP context of the user equipment 30 where no TFT is transferred from the UE to the GGSN. These steps show as a first non-limiting example an activation process using the 3G/GPRS network domain. However it would be appreciated that this process could be carried out in embodiments of the present invention using any of the other radio domains which allow PDP context requests.

At step 101, the user equipment 30 may send an ‘Activate PDP Context Request’ to the SGSN 34. The message may include information regarding the IMSI, PDP Address, Access Point Name (APN), QoS Attributes.

The SGSN 34 may then validate the request against PDP context subscription records received from the HLR associated with the subscription.

At step 103 The SGSN 34 may then send an ‘Create PDP Context Request’ message to the GGSN. The message may include information such as the IMSI (International Mobile Subscriber Identity), PDP Address, Access Point Name, QoS Attributes.

In addition, the request message may include capability information, for example an indication that a QoS Upgrade is supported by the SGSN 34 and/or that ARP Modification is supported by the SGSN 34.

At step 104, upon receiving the request message, the GGSN 40 may then create a PDP context. The GGSN 40 may be configured such that it has a record of access point names (APN).

At step 105, confirmation of the decision that a request may be created is started. The GGSN 40 may then send a ‘Create PDP Context Response’ message to the SGSN 34. This message informs the SGSN 34 of various attributes, such as Quality of Service attributes. For example, the message may include QoS attributes regarding the ARP, maximum bitrate, guaranteed bitrate, traffic class, traffic handling priority, and so on.

At steps 107a and 107b, the radio access bearer establishment is then initiated by the SGSN 34.

At the end of the above steps the user equipment has now established a context communication with the GGSN without a TFT having been transmitted from the user equipment to the GGSN. The above process thus produces a TFT-less GTP user and control tunnel over which the user equipment may communicate.

The example provided above established a context communication with the GGSN without a TFT via a SGSN via a 3G/GPRS radio access network. It would be understood by the person skilled in the art that the user equipment would be equally be able to establish a context communication with the GGSN without a TFT via any other acceptable radio access network. For example the user equipment may in some embodiments establish a context communication with the GGSN without a TFT via an I-WLAN radio access network. In such embodiments the UE would establish the context via the TTG 53, where GTP-U and GTP-C tunnels would be established between the TTG and the GGSN. The Establishment of a tunnel in a I-WLAN radio link is defined in the 3GPP technical specification 23.234 and in particular in section F.3.1. In particular the message sent is a ‘E2E Tunnel Establishment request’.

In embodiments of the invention the user equipment 30 may establish more than one context request to the GGSN over more than one separate wireless access domain. For example a first context can be established as described with regards to step 101 to 107, and a second context established via the I-WLAN radio access network.

Steps 109 to 111 show the activation process when UE accesses via WLAN concurrently and UE happens to have the same IP address for both connections and both the Access Point Node (APN) and the Interworking-Access Point Node (I-APN) resolve to the same Access Point (AP). As mentioned above the UE may establish a tunnel to the TTG in order to set up another PDP context to the GGSN, this time for its I-WLAN connection. The TTG may then try to establish a corresponding PDP context at the GGSN. Since UE ca not send a TFT to the TTG, the PDP context sent to the GGSN does not have a TFT. In steps 109 to 111 it is shown how the GGSN in embodiments of the present invention is configured to have two primary PDP contexts to the same APN both having the same IP address and where the GGSN has not received a TFT. This as described in this example may be in embodiments where the radio access domains of the PDP contexts are different for example where one is a I-WLAN and the other is a GPRS, or where in an embodiment one of the RAT types is an I-WLAN.

At step 109 the user equipment transmits a first uplink packet. In one embodiment where the user equipment is connecting via a TFT-less context over a GPRS radio domain, this packet may be a user data packet transmitted over the GTP-U tunnel or may be a control data packet transmitted over the GTP-C tunnel. In other embodiments of the invention where the user communication is connecting via a TFT-less context via a TTG over a I-WLAN radio domain, the packet from the TTG to the GGSN may be a user data packet transmitted over the GTP-U tunnel or may be a control data packet transmitted over the GTP-C tunnel.

At step 111, the GGSN on receiving this first packet, determines that this packet has been received via a TFT-less tunnel for a particular PDP context. On determining that there is no TFT for this PDP context the GGSN creates and stores a local TFT for the PDP context.

The local TFT for the PDP context may include a source/destination IP address, port number, IP protocol type and choice of transport protocol (e.g. UDP or TCP).

As the GGSN has created a TFT for this particular PDP context, this TFT may be applied when the user equipment requests a further PDP context via a different radio access domain.

Furthermore the GGSN created TFT may be used in order to determine any down-link routing of packets to the IP address of the user, and may further be used to implement a dynamic creation of TFTs for the PDP contexts at the GGSN based on the L3/L4 service awareness features.

For example if the original context was via the 3G/GPRS radio access domain and the user equipment transmits a request for a further session context via the TTG and I-WLAN access network, the TTG may then transmit a context request message to the GGSN. This context request would determine that the GGSN currently holds local TFT for the same PDP context APN pair and would modify the local TFT to determine for the down-link which packets are to be transmitted over which radio access network to reach the user equipment.

Thus in embodiments of the invention following the generation of the TFT the GGSN may receive downlink user plane IP packets, and may look up the destination IP address (the UE IP address) using the generated TFTs. Where the UE has multiple contexts active the GGSN is required to find out which GTP-U tunnel is the correct one (thus packets to be sent by the SGSN GTP-U tunnel require the SGSN's user plane IP address and SGSN's TRID-D).

Thus in summary, the GGSN in embodiments of the invention may on receiving up-link packets before down-link packets, on receiving a first up-link packet via one of the TFT-less tunnels, the GGSN may create a local TFT for this PDP context. This packet may be a user data packet transmitted over the GTP-U tunnel or may be a control data packet transmitted over the GTP-C tunnel.

Steps 151 to 155 show the case where the GGSN receives a downlink packet before any uplink packet has been received.

In step 151 the GGSN receives a downlink packet.

In step 153, in the absence of a TFT the GGSN selects the best bearer session. This selection may be carried out based on local configuration data. In this embodiment the GGSN has knowledge of the characteristics of the various access technologies and selects one access network over a different one based on this configuration information. Thus for example the incoming packet is time sensitive the GGSN selects the access network with the lowest delay configuration.

In other embodiments of the invention the GGSN uses a heuristic rule.

In step 155 the packet is transmitted in the tunnel selected in step 153. Furthermore the user equipment on receipt of the packet forwards the packet to the correct application.

These initial selection criteria may be stored as a temporary TFT until a first uplink packet is received from the UE via a TFT-less tunnel thus invoking step 111.

It shall be appreciated that whilst embodiments of the present invention have been described in relation user equipment such as mobile stations, embodiments of the present invention are applicable to any other suitable type of user equipment.

In the above described examples the capability information associated with the capabilities of the serving controller. However, the invention is not limited to such embodiments but may also be applied to situation wherein the capability information associates with another node, for example with a user equipment.

The examples are explained with reference to PDP contexts. In alternative embodiments of the invention any suitable communication sessions may be controlled accordingly.

The embodiment of the present invention has been described in the context of a communication system that is based on a GPRS system. This invention is also applicable to any other communication systems where similar problems may exist.

It is also noted herein that while the above describes exemplifying embodiments of the invention, there are several variations and modifications which may be made to the disclosed solution without departing from the scope of the present invention as defined in the appended claims.

Although the document describes that the first radio access network is a 3G/GRPS access network and the second radio access network is a I-WLAN access network, it would be appreciated by the person skilled in the art that the user equipment may be in wireless communication with two or more access networks at the same time which may be domains other than the two provided in the example above. Communication on the wireless interface between the user equipment and the access node(s) can be based on an appropriate communication protocol.

Examples of other possible communication systems enabling wireless data communication services, without limiting to these, include third generation mobile communication system such as the Universal Mobile Telecommunication System (UMTS), i-phone or CDMA2000 and the Terrestrial Trunked Radio (TETRA) system, the Enhanced Data rate for GSM Evolution (EDGE) mobile data network. Other possible communication systems enabling wireless data communication services within which embodiments of the invention could be employed include those employing the WiMax (Worldwide Interoperability for Microwave Access) standards. These may be compliant with for example IEEE 802.16, HiPerman (High Performance Metropolitan Access Network), or WiBro (Wireless Broadband) standards. Further examples of possible communication systems enabling wireless data communication services within which embodiments of the invention could be employed include WLAN (Wireless Local Area Network) communication systems such as those using any of the IEEE 802.11 standards. Examples of fixed line systems include the diverse broadband techniques providing Internet access for users in different locations, such as at home and offices. Regardless the standards and protocols used for the communication network, the invention can be applied in all communication networks wherein registration in a network entity is required.

The invention is not limited to environments such as cellular mobile or WLAN systems either. The invention could be for example implemented as part of the network of computers known as the “Internet”, and/or as an “Intranet”. Furthermore the user equipment 14 in some embodiments of the present invention can communicate with the network via a fixed connection, such as a digital subscriber line (DSL) (either asynchronous or synchronous) or public switched telephone network (PSTN) line via a suitable gateway.

The above described operations may require data processing in the various entities. The data processing may be provided by means of one or more data processors. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a location server.

It is also noted that while the above describes exemplifying embodiments of the invention, there are several variations and modifications which may be made to the disclosed solution without departing from the scope of the present invention as defined in the appended claims.

1. A node configured to communicate with a user equipment via at least two access network domains, wherein the node is configured to generate access network domain selection information, and wherein the node is further configured to route data packets dependent on the network domain selection information.

2. The node as claimed in claim 1, wherein the node is further configured to generate the access network domain selection information dependent on receiving a first data packet from the user equipment via at least one of the access network domains.

3. The node as claimed in claim 2, wherein the node is further arranged to edit the access network domain selection information dependent on receiving a further data packet from the user equipment via a further access network domain.

4. The node as claimed in claim 1, wherein the access network domain selection information is a traffic flow template filter.

5. The node as claimed in claim 4, wherein the traffic flow template filter comprises a context filter which identifies each context with an access network domain.

6. The node as claimed in claim 5, wherein each context comprises a Packet Data Protocol Context.

7. The node as claimed in claim 2, wherein the first data packet from the user equipment via at least one of the access network domains comprises a tunnelled packet.

8. The node as claimed in claim 7, wherein the tunnelled packet is a GPRS Tunnelling Protocol (GTP) packet.

9. The node as claimed in claim 7, wherein the tunnelled packet comprises a first packet transmitted via a first context.

10. The node as claimed in claim 1, wherein the node is a Gateway GPRS support node (GGSN).

11. The node as claimed in claim 1, wherein the node is configured to generate access network domain selection information dependent on at least one characteristic of the at least two access network domains.

12. The node as claimed in claim 1, wherein the characteristic of the at least two access network domains comprises at least one of:
transmission delay;
error rate; and
bandwidth.

13. The node as claimed in claim 1, wherein the at least one access network domain comprises at least one of:
3G radio access network;
GRPS radio access network;
I-WLAN radio access network;
Universal Mobile Telecommunication System (UMTS) radio access network;
i-phone radio access network;
CDMA2000 radio access network;
Terrestrial Trunked Radio (TETRA) system radio access network;
Enhanced Data rate for GSM Evolution (EDGE) radio access network;
Worldwide Interoperability for Microwave Access (WiMax) radio access networks;
A IEEE 802.16 compliant radio access network;
High Performance Metropolitan Access Network (HiPerman); and
Wireless Broadband (WiBro) access network.

14. A node as claimed in claim 2, wherein the node is configured to generate access network domain selection information further dependent on determining the absence of current access network domain selection information in the node.

15. A node configured to communicate with a user equipment via at least one radio access network domain, wherein the node is configured to generate radio access network domain selection information on receiving a first packet from the user equipment via the first radio access network domain, and wherein the node is further configured to select at least one radio access network domain to transmit packets to the user equipment dependent on the radio access network domain selection information.

16. A node configured to communicate with a user equipment via at least two access network domains, wherein the node comprises:
means for generating access network domain selection information; and
means for routing data packets dependent on the network domain selection information.

17. A method for communicating with a user equipment via at least two access network domains, comprising:
generating access network domain selection information, and
routing data packets dependent on the network domain selection information.

18. The method as claimed in claim 17, comprising
receiving a first data packet from the user equipment via at least one of the access network domains; and
generating the access network domain selection information dependent on receiving the first data packet from the user equipment via at least one of the access network domains.

19. The method as claimed in claim 18, further comprising:
receiving a further data packet from the user equipment via a further access domain;
editing the access network domain selection information dependent on receiving a further data packet from the user equipment via a further access network domain.

20. The method as claimed in claim 17, wherein the access network domain selection information is a traffic flow template filter.

21. The method as claimed in claim 20, wherein the traffic flow template filter comprises a context filter which identifies each context with an access network domain.

22. The method as claimed in claim 21, wherein each context comprises a Packet Data Protocol Context.

23. The method as claimed in claim 18, wherein the first data packet from the user equipment via at least one of the access network domains comprises a tunnelled packet.

24. The method as claimed in claim 23, wherein the tunnelled packet is a GPRS Tunnelling Protocol (GTP) packet.

25. The method as claimed in claim 23, wherein the tunnelled packet comprises a packet transmitted via a first context.

26. The method as claimed in claim 17, comprising generating access network domain selection information dependent on at least one characteristic of the at least two access network domains.

27. The method as claimed in claim 26, wherein the characteristic of the at least two access network domains comprises at least one of:
transmission delay;
error rate; and
bandwidth.

28. The method as claimed in claim 17, wherein the at least one access network domain comprises at least one of:
3G radio access network;
GRPS radio access network;
I-WLAN radio access network;
Universal Mobile Telecommunication System (UMTS) radio access network;
i-phone radio access network;
CDMA2000 radio access network;
Terrestrial Trunked Radio (TETRA) system radio access network;
Enhanced Data rate for GSM Evolution (EDGE) radio access network;
Worldwide Interoperability for Microwave Access (WiMax) radio access networks;
A IEEE 802.16 compliant radio access network;
High Performance Metropolitan Access Network (HiPerman); and
Wireless Broadband (WiBro) access network.

29. A method as claimed in claim 18, wherein generating the access network domain selection information is further dependent on determining the absence of current access network domain selection information in the node.

30. A computer program product configured to perform a method for communicating with a user equipment via at least two access network domains, comprising:
generating access network domain selection information, and
routing data packets dependent on the network domain selection information.

31. A communications system comprising: a user equipment and a node, wherein the user equipment and node are configured to communicate via at least a first network domain and at least a second network domain, wherein the node is arranged to generate access network domain selection information, and wherein the node is further configured to route data packets dependent on the network domain selection information.

32. A communications system comprising: a user equipment and a node, the node configured to communicate with a user equipment via a first access network domain and a second access network domain, wherein the user equipment communicates to the node via the first and second access networks concurrently.

33. A communications system as claimed in claim 32, wherein the user equipment is configured to identify the node by a single internet protocol address, and access point name independent of the access network domain communication path.
